(19) United States
(12) Patent Application Publication
(10) Pub. No.: US 2026/0203994 A1
(43) Pub. Date: Jul. 16, 2026

(54) METHOD FOR 3D MEASUREMENT OF AN ENVIRONMENT AND SCANNING ARRANGEMENT

(71) Applicant: ZOLLER & FRÖHLICH GMBH, Wangen im Allgäu (DE)

(72) Inventor: Christoph Fröhlich, Wangen (DE)

(21) Appl. No.: 19/136,843

(22) PCT Filed: Dec. 6, 2023
(86) PCT No.: PCT/EP2023/084474

§ 371 Date: Jun. 6, 2025

(30) Foreign Application Priority Data
Dec. 9, 2022 (DE) 10 2022 132 826.0

(51) Int. Cl. G06T 15/08; G01S 7/48; G01S 7/481; G01S 17/89; G06T 7/33; G06T 7/73; G06T 15/06

(52) U.S. Cl. CPC G06T 15/08; G01S 7/4808; G01S 7/4817; G01S 17/89; G06T 7/337; G06T 7/74; G06T 15/06; G06T 2207/10028

(57) ABSTRACT

A method and system for three-dimensional (3D) measurement of an environment using a scanning arrangement is disclosed. The method includes positioning a scanning device, capturing scan data to generate a spatial image, registering the scan data to a common coordinate system, and converting the data into a voxel-based 3D structure. Unmeasured areas are identified, and candidate positions for subsequent scans are determined based on predefined boundary conditions, including minimum and maximum distances from previous scan positions. The candidate positions are analyzed to identify a new scanning position, which is then used to acquire additional scan data. The process is repeated iteratively until the environment is fully scanned.

### CROSS REFERENCE TO RELATED APPLICATIONS

The present patent application is a national stage of, and claims priority to, Patent Cooperation Treaty Application No. PCT/EP2023084474, filed on Dec. 6, 2023, which application claims the priority of the German patent application DE 10 2022 132826.0, filed on Dec. 9, 2022, the disclosures of which are incorporated in the present patent application by reference.

### TECHNICAL FIELD

The disclosure relates to a method for measuring an environment and a scanning arrangement operated according to such a method.

### BACKGROUND

The 3D measurement of objects using laser scanners is of considerable importance in practice. In case of complex objects or objects difficult to access, several laser scans always are taken in succession from different positions and are stored in a common project folder, the scans then requiring to be transferred to a common higher-level coordinate system. This process is referred to as “registration.” Applicant's patent EP 3 056 923 B1 describes a scanning arrangement in which this registration is carried out in the field using a handheld device, with another scanning process being carried out in parallel by means of a laser scanner.

The problem with such solutions is positioning the laser scanner (2D or 3D) in the field in such a way that the entire environment to be surveyed is actually captured. When scanning a larger or contorted environment, considerable experience is required to select the appropriate positions for the scanner-nevertheless, it often happens that not the entire environment is measured comprehensively, so that time-consuming re-measurement is necessary to fill in existing gaps.

WO 2022/074083 A1 that also goes back to Applicant discloses a mobile scanning arrangement that can be operated in SLAM mode. The scanning arrangement is mounted on a carrier vehicle, such as, for example, a SKID or an AGV, or positioned on kind of a backpack carried by a person moving in the environment to be measured. This mobile scanning arrangement has a computing unit that is in communication to the scanning device, e.g., a 2D or 3D scanner. Moreover, the scanning arrangement is equipped with a device for position detection, the computing unit being designed to evaluate the data collected by the scanning device, for example, operated in an MMS-SLAM rotation mode, and the device for position detection, and to determine a motion path of the scanning device. Furthermore, the computing unit is adapted to determine at least one position for performing a static scan if the data quality of the motion path (trajectory) or the resulting scan is insufficient. Such a mobile scanning arrangement can be applied very flexibly in environments in which a carrier vehicle or a person can move unhindered. However, this concept reaches its limits in environments where free movement is not possible.

In such cases, the first scanning process is preferred, involving the recording of static scans from several positions.

Mobile autonomous robots use systems in which a map of the environment is generated in parallel via a scanning device while the robot is moving, enabling the robot to orient itself within the environment. However, such concepts are not concerned with the exact measurement of the environment and a measurement object, respectively, but merely with measuring the environment in which the autonomous robot is to be moved.

### SUMMARY

In view of this, the object of the disclosure is to provide a method for measuring an environment and a scanning arrangement operable according to such a method, which enable precise detection of even complex environments.

The method according to the disclosure for 2D or 3D measurement of an environment is performed according to the following steps, the succession of the method steps being variable.

In a first step, a scanning arrangement is positioned at a position in the environment to be measured in a manner known per se, and by means of suitable control of a scanning device hereinafter referred to as scanner-the environment is scanned and then, through appropriate evaluation, as described, for example, in initially indicated EP 3 056 923 B1, a spatial image of the visible surface of the environment is created. This image is articulated, for example, as a 3D point cloud and provides a scale model of the environment.

This scan data is then fed to possibly already recorded existing data (which will be dealt with later) and aligned to the correct location in a common reference system. Accordingly, the scan is registered in this project-specific coordinate system.

In a further method step, the registered scan data is converted into a 3D database and a 3D data structure cloud is created from this database.

Up to this point, data acquisition does not differ from that of conventional scanning systems.

In a subsequent preparatory step, these 3D data structures are analyzed in the manner described below and candidates for possible scanner positions are generated in parallel. The 3D data structure cloud is classified into 3D data structures that are assigned measurement coordinates and those that are not assigned measurement coordinates. The latter 3D data structures thus represent hidden or non-visible areas of the measured environment.

In a further step, candidate positions are determined from the 3D data structures without measurement coordinates according to predetermined boundary conditions, and then, preferably by ray tracing, scan images of the determined candidate positions are simulated.

The results of this simulation are then analyzed and a new specific position is selected according to specified criteria.

The scanner is then moved to this new static position and another scan is initiated. This is then evaluated in the manner described above, repeating the process until the environment has been completely captured and all 3D data structures have been filled with measurement coordinates.

The concept according to the disclosure thus enables measurement of an environment, for example during a construction survey, without prior knowledge of this environment, the best next scanner position (best next view) having the greatest potential to extend the already captured environment geometry in the peripheral areas and to complete it within itself, being suggested by way of spatial analysis. As will be explained in more detail below, these position suggestions must take into account the physical conditions of the scanner measurement setup, e.g., accessibility, setup height, and minimum distance.

In an example of the disclosure, the 3D data structure cloud is implemented as a voxel cloud.

As already indicated above, the simulation is performed by ray tracing, i.e., by virtually scanning the voxel cloud with radial rays from a fictitious nodal point of the original scan.

In the above classification of the 3D data structure cloud (voxel cloud), data structures (voxels) without measurement coordinates a distinction is made between parts that, in relation to a nodal point, are located behind and/or in front of a 3D data structure (voxel) filled with measurement coordinates.

The computational effort can be reduced further if ground coordinates are extracted from the 3D data structure cloud (voxel cloud) before determining the position coordinates, whereby these extracted ground coordinates can be further reduced according to certain boundary conditions relating to the ground or position.

Such boundary conditions require, for example, that discontinuities on the ground are avoided when selecting the new position. Furthermore, to improve measurement accuracy, a minimum and maximum distance between the position and a previous position is specified, and, in addition, a minimum space above a ground point is required to take into account the set-up height of the scanning device.

When analyzing the position candidates for selecting a new position from the aforementioned extracted ground coordinates, criteria, such as the number of 3D data structures, in particular voxels, without measurement coordinates in the visibility range of the position candidate, or the point density or point resolution in the viewing area assigned during the creation of the 3D data structure (voxel) can preferably be taken into account.

In an example, the analysis can take into account the number of 3D data structures, in particular voxels, without measurement coordinates in the viewing area behind a 3D data structure (voxel) filled with measurement coordinates.

In this analysis, hole edges and hole edge areas of the 3D data structures, in particular voxels, are also taken into account to improve measurement accuracy.

As explained above, the analysis of the position candidates can be performed using ray tracing according to the criteria mentioned above. The position candidates extracted in this way then form the basis for selecting a new position.

The scanning arrangement according to the disclosure provides for data processing for determining a new position in the field to be carried out by means of a handheld device/tablet, for example, that is in data communication with the scanning device or a computer integrated into the scanning device.

Examples of the disclosure will be explained in more detail below with reference to schematic drawings, in which

### BRIEF DESCRIPTION OF THE DRAWINGS

FIG. 1 shows the basic structure of an example scanning arrangement according to this disclosure.

FIG. 2 shows a workflow of an example method according to the disclosure for 3D measurement of an environment.

FIG. 3 shows a detailed representation of the workflow according to FIG. 2.

### DESCRIPTION

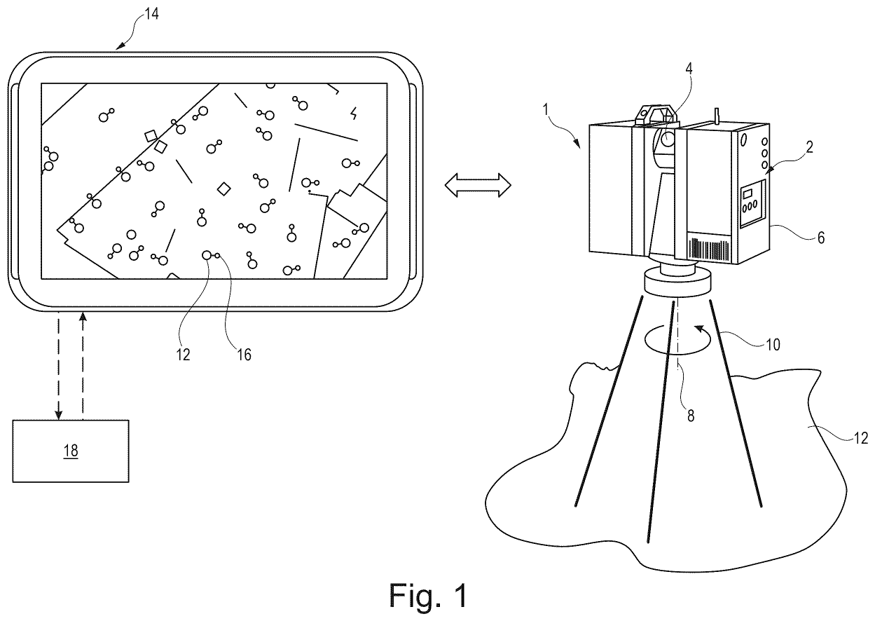

FIG. 1 shows the basic structure of a scanning arrangement 1 according to the disclosure. It has a scanning device, for example a 3D laser scanner 2, as is offered by applicant under the trademark Z+F-Imager®. This laser scanner 2 has a rotating measuring head 4 that rotates around a horizontal axis (view according to FIG. 1) and via which a laser beam is directed to the environment to be measured. A transmitting and receiving unit of the laser scanner 2 is arranged in a housing 6 which can be pivoted through at least 180° about a vertical pivot axis 8, so that the environment can be scanned almost completely by pivoting the housing 6 about the pivot axis 8 and thereby rotating the measuring head 4. The laser scanner 2 is positioned in the environment via a tripod 10 or the like—this area of the environment is referred to below as position 12.

The housing 6 may contain a memory for the scan data as well as an evaluation unit via which the recorded scan data can be evaluated. This evaluation, in particular the registration/pre-registration, can also be done by means of a tablet 14 or handheld device shown in FIG. 1, which is preferably in contactless data communication with the laser scanner 2. This data connection can be established for example, via Bluetooth or a connection regulated according to WiFi standard. To determine the scanner position and orientation, the laser scanner 2 can be equipped with an integrated navigation system that enables, for example, GNSS-independent determination of the absolute position of the laser scanner 2 or at least a relative position to a known location in the environment (in the field).

This tablet 14 is used to perform preferably targetless registration of the scan, which is facilitated by the fact that the position of the laser scanner 2 and its orientation are known either relative to a previously known location or as an absolute position. After complete measurement of the environment as described below, a field book with the positions 12 and the scanner orientation 16 is stored in tablet 14. As indicated in FIG. 1, the results may then be transmitted to a central server 18 after complete measurement, for example via a WLAN connection.

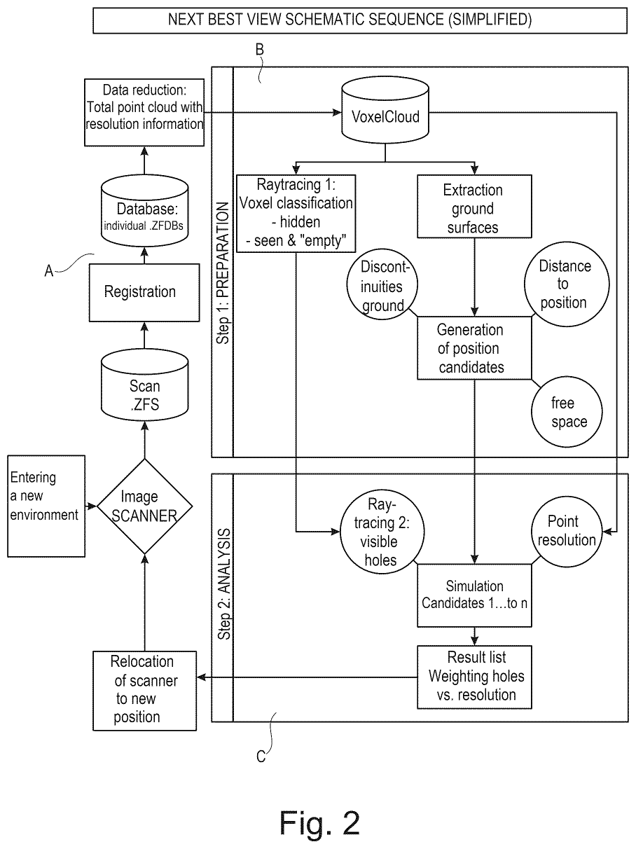

FIG. 2 shows the basic steps of the method according to the disclosure for determining the “next best view.” The workflow according to the disclosure can be divided into the main steps of Data Acquisition A, Preparation B, and Analysis C. Data Acquisition A is carried out for the most part using the usual methodology. In the example shown, the scanning arrangement 1 explained in FIG. 1 is used with a laser scanner 2, hereinafter referred to as the scanner. In principle, however, other scanning arrangements can also be employed for 2D or 3D measurement.

As indicated in the workflow, the scanner 2 according to the disclosure is moved into the environment by the person performing the measurement process, and positioned at a preselected position 12 via the tripod 10. The scanner 2 is then controlled in a manner known per se so that a first image is created with capturing a spatial image of the visible surface of the environment articulated as a point cloud.

The resulting scan, or more precisely, the scan data reproducing a scale model of the captured environment, is then registered in the next method step, whereby this scan data being fed to existing data possibly captured in a previous step and being aligned correctly in terms of location to a common, superordinate reference/coordinate system.

Up to this point, the method according to the disclosure corresponds to a conventional scanning process.

After registration, the scan data is converted into a database, the data structure being prepared for comprehensive spatial analysis, thus enabling a subsequent spatial point query to be carried out more efficiently.

In the next method step, a 3D data structure cloud, in the present case a voxel cloud, is created from this database, whereby, so to speak, a cube structure with a defined edge length is generated, whose components (voxels) numerically contain properties such as the point density. Accordingly, this step reduces the data to a total point cloud with resolution information.

The voxel cloud resulting from the data reduction, according to the disclosure, is then further processed in two parallel steps, properties being assigned to the components (voxels) in the manner described below. At the same time, candidates for possible scanner positions are generated by way of selection based on specified boundary conditions.

As shown in Preparation B on the left, the method according to the disclosure first performs an initial ray tracing, in which the voxels of the voxel cloud are classified with attributes. The voxels are virtually scanned with radial rays from the nodal point of the original scan, and classified. According to the disclosure, this classification is performed by distinguishing between at least three groups:
a) “seen”—these are voxels filled with measurement coordinates, which therefore do not require any additions;
b) “empty”—this refers to voxels without measurement coordinates that are located in front of a “seen” voxel on the virtual scanning beam;
c) “hidden”—this grouping refers to voxels without measurement coordinates that are located directly behind a “seen” voxel on the virtual scanning beam.

The voxels classified in this way are then processed further in the manner described in more detail below.

Parallel to the classification of the voxels into “seen,” “empty,” and “hidden,” the ground surfaces are extracted as shown in Preparation B in FIG. 2 on the right. This results from the condition that a scanner position is usually only physically possible on a ground surface, so that this is determined using a search algorithm and marked as a voxel group (containing the position candidates) in the voxel cloud.

The extracted ground areas are then reduced to voxel groups that reflect the candidate positions using boundary conditions. Such boundary conditions may vary depending on the scanning task. For example, it can be specified that the voxel groups must not contain any discontinuities on the ground, so that positions that are arranged in a step area or other uneven areas are avoided. Furthermore, voxel groups are considered that lie within an area defined by a minimum distance and a maximum distance in relation to completed positions (from previously performed scans). Furthermore, a certain minimum free space above the respective ground point may be required so that the installation height and a minimum measuring distance of the scanner 2 are taken account of.

As mentioned above, these boundary conditions can be expanded depending on the scanning task.

The position candidates generated in this way are then arranged in a regular grid and analyzed in the sequence marked with Analysis C. The results from Preparation B are superimposed and a scan is simulated again to determine the “next best position” (Next-Best-View).

The position candidates determined using Preparation B are again analyzed using ray tracing (Raytracing 2) according to, for example, two criteria, whereby these criteria again are, of course, variable and expandable. In this example, the number of visible holes is taken into account These are voxels classified as “hidden” from Preparation B in the viewing area of position candidates. These voxels assigned to the “visible holes” preferably contain information about both the hole edges and the hole edge areas. Another criterion is the point density-here, the point density assigned to the voxel during the creation of the voxel cloud is regarded.

This analysis is performed for each position candidate and stored. The results of the simulation described above (Raytracing 2) are then compared and listed in order of importance, with the position with the highest rating being the new position sought (next-best-view).

The scanner 2 is then relocated to the new position determined in this way and a new scan is started. This process is repeated iteratively until the environment is completely captured and thus only voxels linked to measurement coordinates remain.

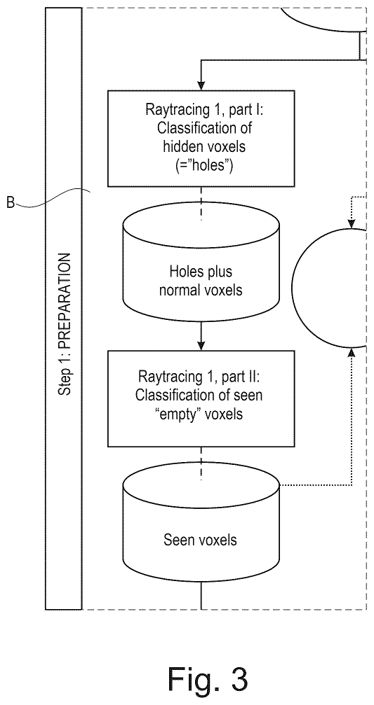

FIG. 3 shows the Raytracing 1 described above in Preparation B in more detail.

As explained above, in the Raytracing 1 performed in the preparation step, the components of the voxel cloud are first classified according to the attribute “hidden”—i.e. voxels without measurement coordinates that are located directly behind a “seen” voxel on the ray tracing scanning beam (“holes”) are classified, so that after this sub-step, the “normal” voxels (“seen”) and the “hidden” voxels are extracted.

In part 2 of Raytracing 1, according to Preparation B, the voxels classified as “empty,” i.e., seen “empty” voxels, are then recorded and stored.

This is followed by the second ray tracing step (Raytracing 2) in Analysis C, which was explained in detail in FIG. 2.

As indicated in FIG. 3, the voxels determined by Raytracing I can also be taken into account when extracting the ground areas.

Disclosed are a method for 3D measurement of an environment and a scanning arrangement designed to carry out such a method, wherein, based on a scan carried out, the next best scanner position (Next Best View) is suggested by means of spatial analysis.

### LIST OF REFERENCE SYMBOLS

1 Scanning arrangement
2 Scanner
4 Measuring head
6 Housing
8 Pivot axis
10 Tripod
12 Position
14 Tablet/handheld device
16 Scanner orientation
18 Server
A Data Acquisition
B Preparation
C Analysis

What is claimed is:

1. A method for scanning an environment, comprising
positioning a scanning arrangement at a position in the environment;
scanning the environment using the scanning arrangement and creating a spatial image of visible surfaces of the environment;
registering and/or aligning scan data from the scanned environment to a common reference system;
converting the scan data into a 3D database and creating a 3D data structure cloud;
classifying the 3D data structure cloud into 3D data structures filled with and without measurement coordinates;
determining candidate positions for the scanning arrangement from the 3D data structures without—measurement coordinates according to specified boundary conditions;
simulating scan images from the determined candidate positions;
analyzing the simulated scan images and selecting a new position for the scanning arrangement;
moving the scanning arrangement to the selected new position, and
repeating above steps until the environment is captured.

2. The method according to claim 1, wherein the 3D data structure cloud is a voxel cloud.

3. The method according to claim 1, wherein simulating scan images is performed by ray tracing, including virtual scanning of the 3D data structure cloud, including a voxel cloud, with radial beams from a nodal point of an original scan.

4. The method according to claim 3, wherein the 3D data structures without measurement coordinates contain parts that are located in relation to a nodal point behind or in front of a 3D data structure filled with measurement coordinates.

5. The method according to claim 1, further comprising extracting ground coordinates before determining the candidate positions from the 3D data structure cloud, including a voxel cloud.

6. The method according to claim 5, further comprising reducing the extracted ground coordinates according to boundary conditions relating to the ground and the position.

7. The method according to claim 6, wherein the boundary conditions include:
avoiding discontinuities on the ground;
maintaining a minimum and maximum distance between the position and previous positions; and
maintaining a minimum space above a ground point.

8. The method according to claims 5, further comprising analyzing position data for selecting the new position from the extracted ground coordinates according to:
a number of 3D data structures without measurement coordinates in a viewing area of the determined candidate positions;
a point density or a point resolution in the viewing area assigned to a 3D data structure when creating the 3D data structure cloud.

9. The method according to claim 8, wherein the number of 3D data structures without measurement coordinates in the viewing area behind a 3D data structure filled with measurement coordinates is taken into account in analyzing the position data.

10. The method according to claim 9, wherein hole edges and hole edge areas of the 3D data structures are taken into account in analyzing of the position data.

11. The method according to claim, wherein analyzing of the candidate positions is carried out by ray tracing.

12. The method according to claims 8, wherein the candidate positions resulting from the analyzing of the position data are listed and a selection of the new position is made from this list.

13. The method according to claim 1, wherein data for selecting the new position in the environment is processed by way of a tablet/handheld device in data connection with the scanning arrangement or a computer integrated into the scanning arrangement.

14. A 3D scanning arrangement, which is adapted to be operated in accordance with the method according to claims 1.

15. The method of claim 3, wherein ray tracing further includes distinguishing between seen, empty, and hidden voxels.

16. The method of claim 8, wherein the 3D data structures are voxels and the 3D data structure cloud is a voxel cloud.

17. The method of claim 9, wherein the 3D data structures are voxels.
